(19) United States
(12) Patent Application Publication
(10) Pub. No.: US 2003/0061925 A1
(43) Pub. Date: Apr. 3, 2003

(54) Apparatus for cutting an elongate tube

(76) Inventors: James G. Milliman, Sturgis, MI (US); Galen B. Harman, LaGrange, IN (US)

Correspondence Address: FLYNN THIEL BOUTELL & TANIS, P.C., 2026 RAMBLING ROAD, KALAMAZOO, MI, 49008-1699, US

(21) Appl. No.: 10/252,785

(22) Filed: Sep. 23, 2002

Related U.S. Application Data
(60) Provisional application No. 60/326,339, filed on Oct. 1, 2001.

(51) Int. Cl. B23D 21/14; B26D 1/00

(52) U.S. Cl. 83/178; 83/651

(57) ABSTRACT

An apparatus for cutting an elongate tube includes a cutting head that supports an annular cutting member having a cutting edge. An actuator is provided that includes first and second eccentric mechanisms that project from first and second shafts, respectively, and are connected to the cutting head. A frame plate is connected to the shafts. A passageway extends through the frame plate and is coaxial with the cutting edge of the annular member in an initial non-cutting position thereof. First and second guide plates are positioned on opposite sides of the cutting head. The first guide plate is commonly connected to the first and second shafts and the second guide plate is connected to the first guide plate. A first bore extends through the first guide plate and a second bore extends through the second guide plate. The first and second guide bores are coaxial with the cutting edge of the annular member in an initial non-cutting position thereof.

### FIELD OF THE INVENTION

This invention relates generally to an apparatus for cutting an elongate tube and, more particularly, to an apparatus for cutting an elongate tube including multiple components that are configured to have co-axially aligned bores.

### BACKGROUND OF THE INVENTION

Devices for cutting long lengths of tubular stock into smaller length portions are known in the art. Such a device is disclosed in U.S. Pat. No. 3,568,488, which issued to Franks on Mar. 9, 1971 and is incorporated by reference herein. The Franks patent discloses an apparatus and a method for cutting long lengths of thin walled tubular stock into smaller components and then bending these components into U-shaped members. Once cut and bent, the U-shaped members can be assembled with plural parallel fins to form heat exchange units.

The apparatus disclosed in the Franks patent includes means for driving and advancing a long length of tubular stock along a path, a portion of which extends through a bore in a cutting member. First and second clamping devices, one of which is the belt feed system, are included to secure the tubular stock on opposite sides of the cutting member. The first clamping devices is configured to be moved axially away from the second clamping devices so that the tubular stock can be placed under axial tension.

In operation, a length of tubular stock is inserted through the bores of the cutting member and is secured by the first and second clamping devices. The cutting member is actuated to move from a neutral non-orbiting, non-cutting position to an ever increasing eccentric, or orbital, path so that a cutting blade of the cutting member is moved eccentrically around the outer surface of the tubular stock to effect an ever increasing in depth cut therein. After the cutting member is actuated, the first clamping device is moved away from the second clamping device so that the tubular stock is under axial tension while it is cut by the cutting blade. The partially severed tubular stock is eventually broken into two segments as a result of the tension created by the gripping means.

Burr Oak Tool & Gauge Company, the assignee of both the present invention and the Franks patent, has enjoyed considerable success with the above discussed apparatus. However, it is desirable to make further refinements to the apparatus to enhance its performance.

### SUMMARY OF THE INVENTION

The objects and purposes of the invention are met by providing an apparatus for cutting an elongate tubular element having a base frame that includes a guide. The guide defines a path along which the tubular element is advanced in an axial direction. A drive system is adapted to engage the tubular element and advance it along the path. The apparatus also includes a cutting head that supports an annular cutting member. The annular cutting member has an annular, inwardly extending cutting edge that is substantially coaxial with the path when in an initial non-cutting position thereof and has an inside diameter that is slightly larger than an outside diameter of the tubular element so that the element can be moved along the path through the annular cutting member when in an initial non-cutting position thereof.

An actuator is provided and includes first and second eccentric mechanisms that project from first and second shafts, respectively. The first and second eccentric mechanisms are connected to the cutting head for effecting movement of the cutting head between a non-orbiting position and an eccentric position to cause the annular cutting member to orbit around the tubular element while continuously urging the cutting edge against a radial outer surface of the element. A frame plate is connected to the first and second shafts. A passageway extends through the frame plate and is coaxial with the cutting edge of the annular cutting member. Positioned on opposite sides of the cutting head are first and second guide plates. The first guide plate is connected to the first and second shafts and the second guide plate is commonly connected to the first guide plate. A first guide bore extends through the first guide plate and a second guide bore extends through the second guide plate, wherein the first guide bore and the second guide bore are coaxial with the cutting edge of the annular cutting member when in an initial position thereof.

### BRIEF DESCRIPTION OF THE DRAWINGS

The above and further features and benefits of this invention will be understood by reference to the following detailed description, as well as by reference to the following drawings in which:

FIG. 1 is a side view of an apparatus for cutting an elongate tube into selected lengths and according to this invention;

FIG. 2 is an end view of the apparatus of FIG. 1;

FIG. 3 is a top view of the cutting assembly of the apparatus of FIG. 1;

FIG. 4 is a side cross-sectional view of the cutting assembly of the apparatus of FIG. 1;

FIG. 4A is an enlarged view of the cutting tool area of the cutting assembly of FIG. 4;

FIG. 5 is a front view of the cutting assembly of the apparatus of FIG. 1;

FIG. 6 is a side cross-sectional view of the eccentric mechanism for use with the apparatus of FIG. 1; and

FIG. 6A is a perspective view of the stub shaft in the eccentric mechanism of FIG. 6.

### DETAILED DESCRIPTION

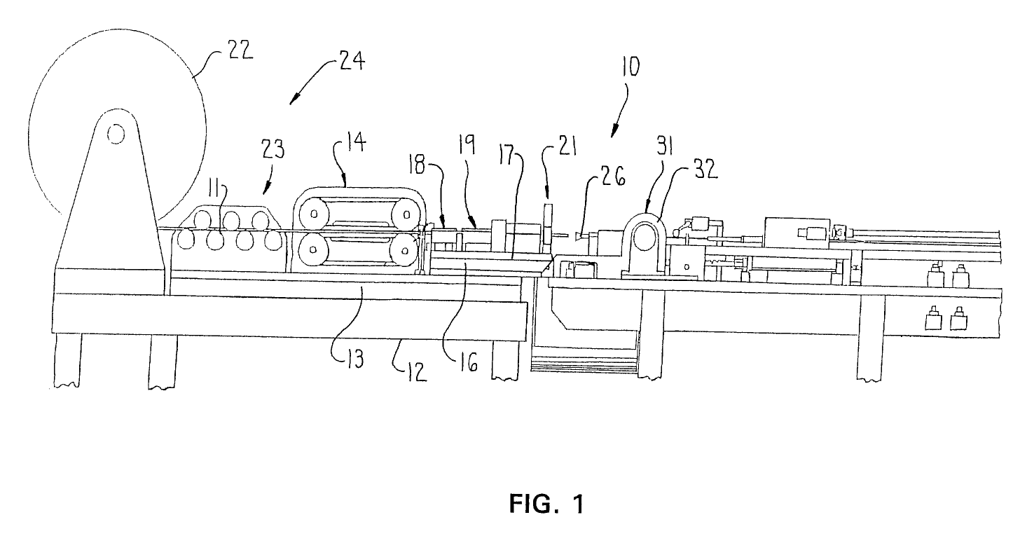

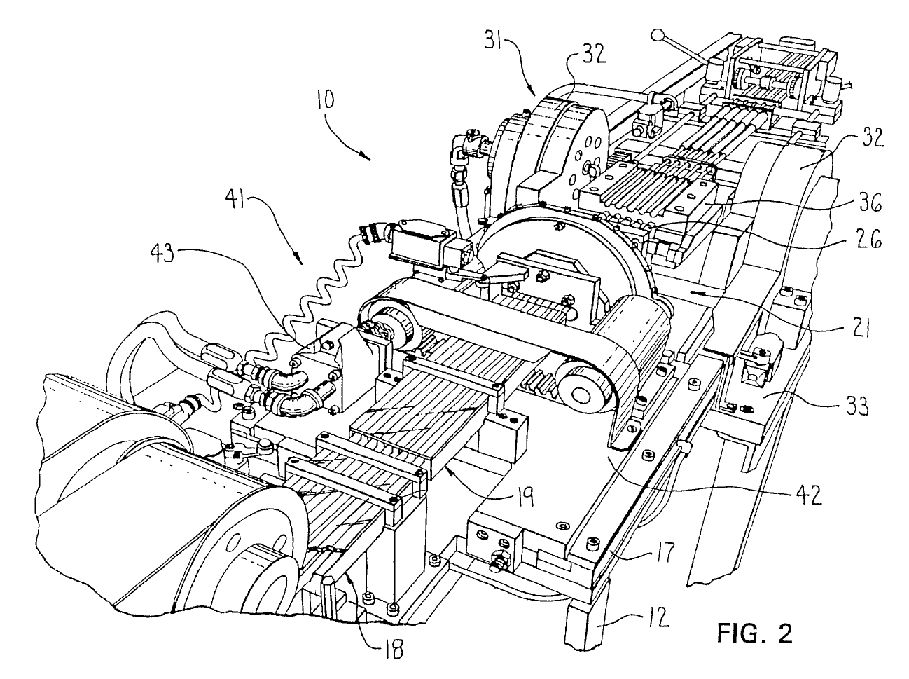

Referring to FIGS. 1 and 2 there is illustrated an apparatus 10 for cutting an elongate tubular stock element 11 into a selected length and according to this invention. A number of the components of the apparatus 10 are identical to components of the tube cutting and bending apparatus disclosed in the aforementioned U.S. Pat. No. 3,568,488 to Franks, which, as stated above, is incorporated by reference herein. Thus, components of this invention that are identical to components of the apparatus disclosed in Franks will not be discussed in detail.

The apparatus 10 includes a base frame 12 that supports a table 13. Mounted to the table 13 are a tube drive 14 and a bed 16. A reciprocating carriage 17, or slide, is supported by the bed 16. The carriage 17 supports a fixed tube guide 18 and a movable tube guide 19 immediately upstream of a tube cutting head 21. The tube guides 18 and 19 define a path on which the tubular element can travel. A tube supply reel 22 and a tube straightening unit 23 are positioned in series at an input end 24 of the apparatus 10. One or more tubular elements 11 are intermittently pulled through rollers of the tube straightening unit 23 by the tube drive 14. The tubular elements 11 are then fed through a tube position detector into the fixed tube guide 18 and then into the movable tube guide 19.

The tubular elements 11 are fed through the cutting head 21 into tube guide pipes 26, which are attached to and movable with a pivoted member of a tube bending unit 31. The bending unit 31 includes a pair of axial support members 32 that project upwardly from a frame 33. The support members 32 pivotally support the tubular elements 11 for movement around a horizontal axis transverse of the apparatus 10. A tube clamp 36 receives and guides the tubular elements 11 from the guide pipes 26 and holds the tube elements 11 as they are bent.

The structures and operation of the supply reel 22, the straightening unit 23, the tube drive 14 and the bending unit 31 are conventional. Thus, further detailed description of these components is believed unnecessary to disclose the structure and process of this invention.

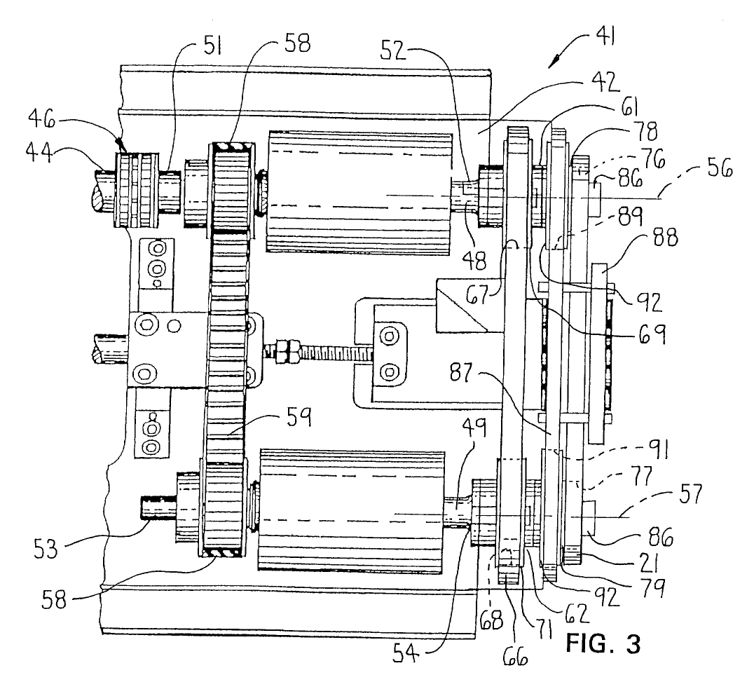

Referring now to FIG. 3, the apparatus includes a cutting assembly 41 supported by a base plate 42. The base plate 42 is rigidly attached to the frame 12 (FIG. 2) and is preferably removably attached, such as by a plurality of bolts. The cutting assembly 41 and the base plate 42 are preferably sized and configured such that they can be attached to an existing apparatus to replace a prior art cutting assembly, such as disclosed in the Franks patent.

A hydraulic or other suitably driven motor 43 (FIG. 2) is supported by the base plate 42. Extending from the motor 43 is a motor shaft 44. Two laterally spaced apart shafts 48 and 49 are rotatably mounted on the base plate 42. The shaft 48 has first and second ends 51 and 52, respectively and the shaft 49 has first and second ends 53 and 54, respectively. The motor shaft 44 is coaxially coupled with the first end 51 of one shaft, illustrated herein as the shaft 48 by a shaft coupling 46. Laterally aligned pulleys 58 are mounted on the first ends 51 and 53 of the respective shafts 48 and 49 and are engaged by an endless timing belt 59 for simultaneous rotation of the shafts 48 and 49 about respective axes of rotation 56 and 57.

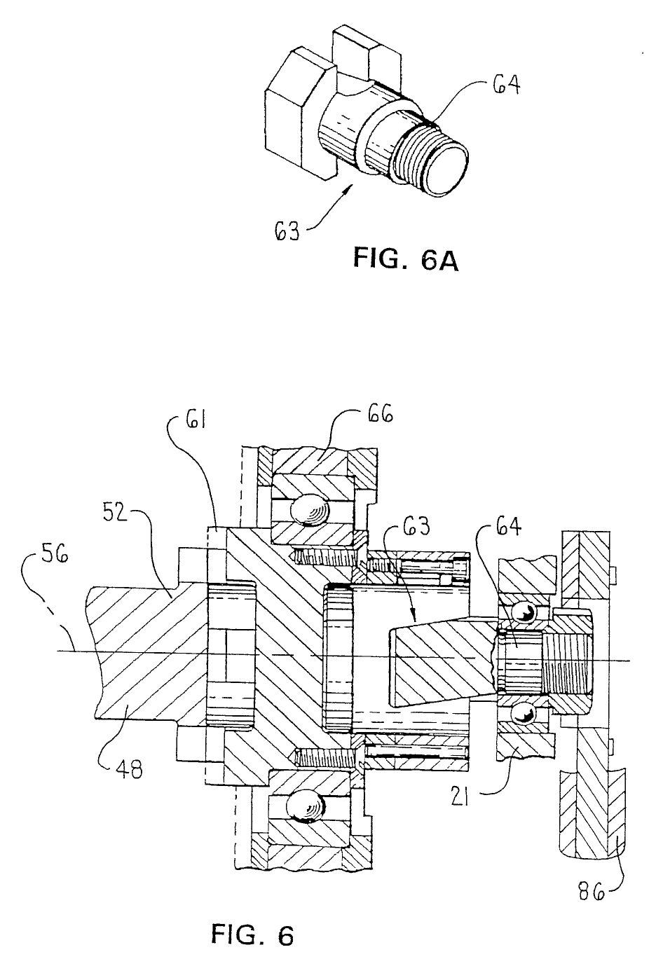

Projecting from the second end 52 of the first shaft 48 is a first eccentric mechanism 61, which is best illustrated in FIG. 6. A second eccentric mechanism 62, identical to the first eccentric mechanism 61, projects from the second end 54 of the second shaft 49. Each of the eccentric mechanisms 61 and 62 are configured to move apart thereof between a non-orbital path and in an eccentric, or orbital, path about the axes of rotation 56 and 57 extending from the respective shafts 48 and 49. Referring in addition to FIG. 6A, extending from each eccentric mechanism 61 and 62 is a flanged stub shaft 63 that has a circular shank 64. These components are conventional and preferably identical to the eccentric mechanisms disclosed in the aforementioned U.S. Pat. No. 3,568,488 to Franks, which as stated above, is incorporated by reference herein. Thus, a detailed description is not believed to be necessary.

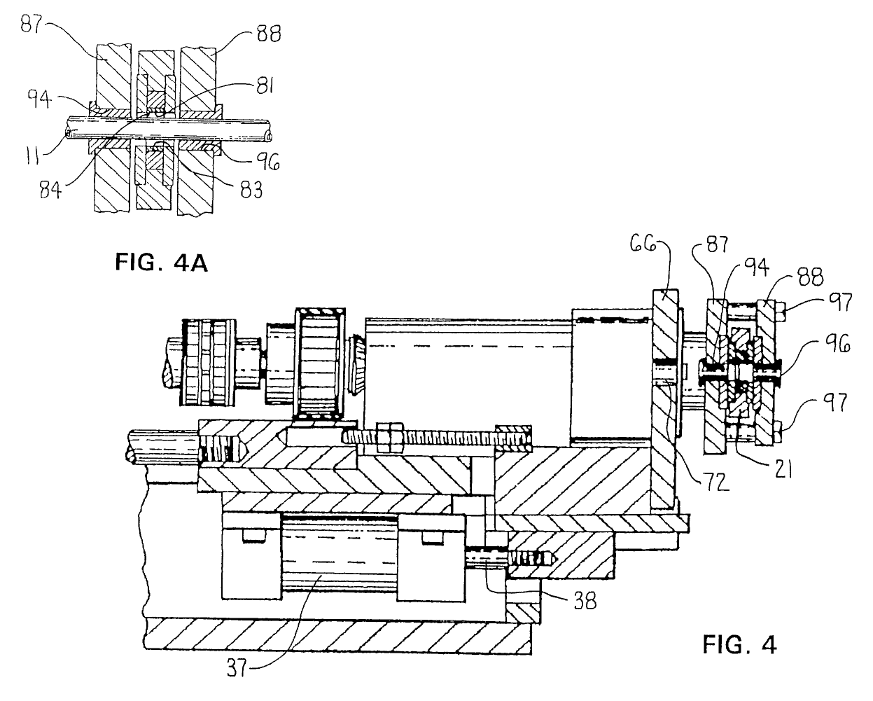

Returning to FIG. 3, the cutting assembly 41 includes a frame plate 66. Extending through opposite ends of the frame plate 66 are parallel openings 67 and 68. A bearing 69 is positioned in the opening 67 and is sized and configured to engage the second end 52 of the shaft 48. An identical bearing 71 is positioned in the opening 68 and is sized and configured to engage the second end 54 of the shaft 49. Extending through a central portion of the frame plate 66 are a plurality of passageways 72 (FIG. 4). Each passageway 72 is coaxially aligned with one of the paths defined by the guides 18 and 19 (FIG. 1).

A cutting head 21 is positioned downstream from the frame plate 66. Parallel openings 76 and 77 extend through the cutting head 21 near the opposite ends thereof. Bearings 78 and 79 are supported in each of the openings 76 and 77 for rotatable engagement and support upon the stub shaft shank 64 (FIG. 6) of the respective eccentric mechanism 61 and 62, which is configured to move to an eccentric location. The cutting head 21 is held in place on the ends of the eccentric mechanisms 61 and 62 by suitable fasteners, such as by nuts.

Referring now to FIG. 4A, a plurality of laterally spaced openings 81 corresponding in number to the number of tubular elements to be simultaneously processed (only one of which is shown in FIG. 4A) extend through the cutting head 21 and each are aligned along a horizontal axis perpendicular to a plane of the cutting head 21. A hollow cylindrical cutting tool 83 is snugly, but slidably, disposed in each of the openings 81. Each hollow cutting tool 83 has an integral, and radially inwardly projecting, annular cutting edge 84 which has an inside diameter that is slightly larger than the outside diameter of the tubular element 11 and is somewhat smaller than an interior diameter of the hollow cutting tool 83.

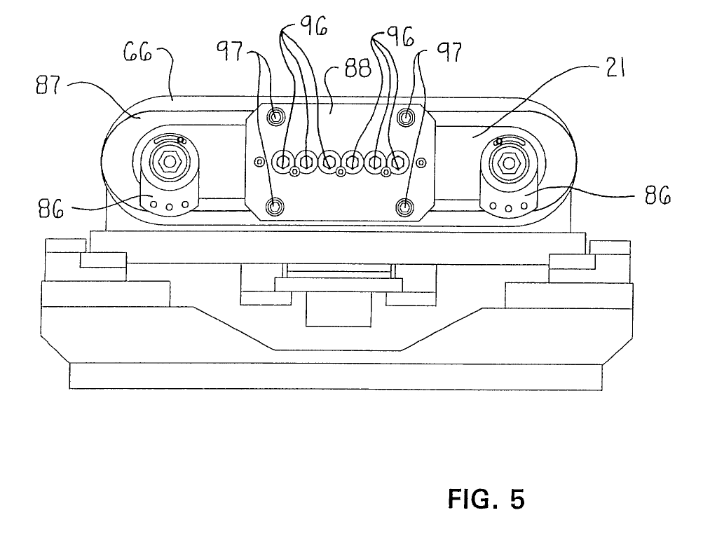

Returning to FIG. 3, when the cutting head 21 is moved by the eccentric mechanisms 61 and 62, so that the axes of the openings 76 and 77 in the cutting head 21 become radially offset from the respective axes of rotation 56 and 57 of the shafts 48 and 49, the orbital movement of the cutting head 21 will impart vibrations to the other components of the cutting assembly 41. In particular, the vibrations are imparted to the shafts 48 and 49 and the axes of rotation 56 and 57 thereof and thence to the cutting head 21 supported on the shafts 48 and 49. As a result, the annular cutting edge 84 (FIG. 4A) is vibrated relative to the tubular element 11 being cut to cause irregular cut patterns to develop. That is, some parts of the remaining material of the tubular element 11 to be cut will be thicker than other parts. Since the tubular element 11 being cut is under tension, the thin parts of the cut will initially snap apart, however, the thicker parts will elongate until thin enough to break The irregular cut end that results is undesirable. Thus, as best illustrated in FIG. 5, in the preferred embodiment of this invention, a counterweight 86 is attached to at least one stub shaft 63 projecting from the eccentric mechanisms 61 and 62 (FIG. 6). One counterweight 86 is thus coupled to the cutting head 21 adjacent the attachment location of each eccentric mechanism 61 and 62. The counterweights 86 are composed of metal or another suitable material. The size and position of the counterweights 86 are selected to reduce, or eliminate, vibration and other undesirable movement caused only by an orbital movement of the cutting head 21. While one configuration has been illustrated herein, those skilled in the art will appreciate that any suitable number of counterweights 86 could be utilized in conjunction with the cutting head 21 to achieve this goal. In addition, the counterweights 86 could be coupled to the cutting head 21 at any suitable location.

As illustrated in FIGS. 3 and 4, first and second parallel guide plates 87 and 88 are positioned adjacent opposite sides of the cutting head 21. Parallel openings 89 and 91 extend through opposite ends of the first guide plate 87. Bearings 92 are received in each of the openings 89 and 91 that are sized and configured to operatively engage the respective shaft 48 and 49. Positioned adjacent each bearing 92 is a flange (not shown) that is configured to prevent movement of the first guide plate 87 along the axes of rotation 56 and 57 of the shafts 48 and 49 are actuated by the motor 43.

Extending through a central portion of the first guide plate 87 are a plurality of bores 94 (FIG. 4A). The inner diameter of each bore 94 is only slightly larger than the outer diameter of the tubular element 11 so that each tubular element 11 can slidingly advance through the first guide plate 87 while simultaneously being supported coaxially with the axis of the bore 94. Each bore 94 is coaxially aligned with one of the paths in the guides 18 and 19 (FIG. 1), as well as with the initial non-cutting neutral position of the passageways 72 in the frame plate 66 and one of the cutting edges 84 (FIG. 4A). As best illustrated in FIG. 4A, the bores 94 define a passageway for guiding the tubular element 11 through the entry side of the cutting head 21 when it is in the neutral non-cutting position.

As best illustrated in FIGS. 4 and 4A, a plurality of bores 96 (FIG. 4A), similar to the bores 94, extend through a central portion of the second guide plate 88. Each bore 96 is coaxially aligned with one of the paths in the guides 18 and 19 (FIG. 1), as well as with one of the passageways 72 in the frame plate 66, one of the bores 94 of the first frame plate 87 and of the cutting edge 84, when it is in its initial non-cutting neutral position. The second guide plate 88 is attached directly to the first guide plate 87 by a number of bolts 97. As best illustrated in FIG. 3, the bolts 97 do not extend through, or otherwise engage, the cutting head 21. Thus, orbital movement of the cutting head 21 will not cause movement of the second guide plate 88. In addition, since the second guide plate 88 is attached directly to the first guide plate 87, the bores 94 and 96 of the first and second guide plates 87 and 88 will remain axially aligned while the cutting head 21 is engaged in eccentric, or orbital, movement.

In practice, the frame plate 66 and the first and second guide plates 87 and 88 can be secured together, for instance, by a clamp for machining purposes. The passageways 72 and the bores 94 and 96 can then be machined simultaneously. In addition, the various attachment openings can be machined in these components while they are secured together. Thus, it will be assured that the passageways 72 and the bores 87 and 88 will be aligned when the cutting assembly 41 is assembled on the shafts 48 and 49.

### Operation

Just prior to a cutting cycle, one or more tubular elements 11 are fed from one or more supply reels 22 through the tube straightening unit 23 and into the tube drive 14. Once the tubular elements 11 have advanced a sufficient distance, the tube drive 14 will stop the advancing movement of the tubular elements 11. The various components of the bending unit 31 are then moved to a position in which the non-moving part of the tubular elements 11 will be given maximum support during the subsequent bending operation.

Once the tubular elements 11 are appropriately positioned, the clamps 36 close around the tubular elements 11. The tubular elements 11 will therefore be secured for the upcoming cutting operation. The tube drive 14 is then actuated to operate in reverse, causing the tubular elements to be pulled axially away from the tube clamp 36. Since the tube clamp 36 tightly grips the tubular element 11 extending therethrough, this action will place the tubular elements 11 under tension. Simultaneous with the tensioning of the tubular element 11, a cut cylinder 37 is activated to retract the piston rod 38 thereof (as disclosed in U.S. Pat. No. 3,568, 488) and thereafter the motor 43 is energized, thus actuating the eccentric mechanisms 61 and 62. Movement of the eccentric mechanisms 61 and 62 causes the cutting head 21 to move in an orbital path. Movement of the cutting head 21 causes the cutting edges 84 of the tools to engage the tubular elements 11 and to cut annular grooves in the peripheral surfaces of the tubular elements 11 extending therethrough.

The cutting edges 84 continue to make an annular cut in the periphery of the tubular elements 11 while continuously penetrating deeper into the outer wall of the tubular elements 11. Recall that the tubular element 11 is under constant strain during the cutting cycle. At some point during the cutting cycle, the tensile strength of the portion of the outer wall of the tubular element 11 that is not yet severed is exceeded and the tubular element 11 breaks. Once the tubular elements 11 are broken, the cut cylinder 37 is actuated to extend the piston rod 38 followed by a retraction of the carriage 17 and thus the cutting assembly 41 to render the cut tube ends free of obstructing structure and thereafter the bending unit 31 is actuated to bend the now severed shorter length of the tubular element 11 into the desired U-shaped member in the same manner as disclosed in U.S. Pat. No. 3,568,488.

The configuration of the present invention improves upon cutting apparatuses for elongated tubes that were previously known. Since the guide plates 87 and 88 are rigidly attached to one another, the passageways 94 and 96 that extend through plates 87 and 88 can be aligned when the apparatus 10 is assembled. These passageways 94 and 96 can be further axially aligned with the initial non-cutting position of the cutting edges 84. Further, since counterweights 86 are attached to each stub shaft 63 of this invention, the cutting head 21 will not vibrate, or wobble, while moving along its eccentric, or orbital, cutting path.

It should be appreciated that the foregoing description is for the purposes of illustration only, and alternative embodiments of this invention are possible without departing from the scope of the claims. For instance, while the second guide plate 88 has been illustrated as being attached to the first guide plate 87, the second guide plate 88 could instead be attached through bearings directly to the first and second shafts 48 and 49. In addition, while a counterweight 86 has been illustrated attached to each stub shaft 63, the apparatus 10 could instead include no counterweights, or any other suitable number thereof.

Thus, although particular preferred embodiments of the present invention have been disclosed in detail for illustrative purposes, it will be recognized that variations or modifications lie within the scope of the present invention and do not depart from the spirit of the invention, as set forth in the foregoing description and drawings, and in the following claims.

What is claimed is:

1. An apparatus for cutting at least one elongate, tubular element into two separate portions, comprising:
a base frame including a guide that defines a path along which said at least one tubular element is advanced in an axial direction;
a drive system adapted to engage said at least one tubular element and advance it along said path;
a cutting head supporting an annular cutting tool having an annular, inwardly extending cutting edge substantially coaxial with said path, said cutting edge having a slightly larger inside diameter than an outside diameter of said at least one tubular element to facilitate said at least one tubular element being movable along said path through said annular tool;
an actuator including a first eccentric mechanism that projects from a first shaft and a second eccentric mechanism that projects from a second shaft, wherein said first and second eccentric mechanisms are connected to said cutting head for effecting movement of said annular tool between a neutral non-orbiting non-cutting position and a position radially offset from an axis of said path so as to orbitally move around said at least one tubular element and a continuous urging of said cutting edge against a radial outer surface of said at least one tubular element to form an ever deepening cut therein;
a frame plate connected to said first and second shafts, wherein a passageway extends through said frame plate and is coaxial with said cutting edge of said annular tool;
a first guide plate and a second guide plate positioned on opposite sides of said cutting head, wherein said first guide plate is supported on said first and second shafts and said second guide plate is commonly supported with respect to said first guide plate; and
a first guide bore extending through said first guide plate and a second guide bore extending through said second guide plate, wherein said first guide bore and said second guide bore are initially coaxial with said cutting edge of said annular tool when in said neutral non-cutting position.

2. The apparatus according to claim 1, wherein at least one counterweight is coupled to said cutting head.

3. The apparatus according to claim 2, wherein said at least one counterweight includes a first counterweight and a second counterweight;
said first eccentric mechanism is attached to said cutting head at a first attachment location and said second eccentric mechanism is attached to said cutting head at a second attachment location; and
said first counterweight is positioned adjacent said first attachment location and said second counterweight is positioned adjacent said second attachment location.

4. The apparatus according to claim 1, wherein said guide includes at least one additional path along which at least one additional tubular element is advanced in an axial direction;
said drive system is adapted to engage said at least one additional element and advance it along said at least one additional path; and
said annular tool includes at least one additional annular, inwardly extending cutting edge that is substantially coaxial with said at least one additional path when in said neutral non-cutting position thereof, wherein said at least one additional cutting edge has a slightly larger inside diameter than an outside diameter of said at least one additional element so that said at least one additional element can be moved along said at least one additional path through said annular tool when in said neutral non-cutting position.

5. The apparatus according to claim 4, wherein at least one additional passageway extends through said frame plate and is coaxial with said at least one additional cutting edge of said annular tool in said neutral non-cutting position;
at least one additional first guide bore extends through said first guide plate and at least one additional second guide bore extends through said second guide plate; and
said at least one additional first guide bore and said at least one additional second guide bore are coaxial with said at least one additional cutting edge of said annular tool in said neutral non-cutting position.

6. The apparatus according to claim 1, including first and second clamps positioned on opposite sides of said cutting head and adapted to engage first and second portions of said tubular element located on opposite sides of said cutting head.

7. The apparatus according to claim 6, including a drive device adapted to effect a movement of at least one of said first and second clamps axially away from an other of said first and second clamps while said actuator is operating.

8. The apparatus according to claim 6, wherein said second clamp is an element of a bending device and a portion of said tubular element clamped by said second grip is bent into a U-shaped form.

9. The apparatus according to claim 1, wherein said second guide plate is connected directly to said first guide plate.

10. A cutting assembly for use with an apparatus having a base frame including a guide that defines a path along which at least one tubular element is advanced in an axial direction and a drive system, wherein said cutting assembly comprises:
a base plate that is removably secured to said base frame;
a cutting head supporting an annular cutting tool having an annular, inwardly extending cutting edge substantially coaxial with said path, said cutting edge having a slightly larger inside diameter than an outside diameter of said at least one tubular element to facilitate said at least one tubular element being movable along said path through said annular tool;
an actuator mounted on said base plate and including a first eccentric mechanism that projects from a first shaft and a second eccentric mechanism that projects from a second shaft, wherein said first and second eccentric mechanisms are connected to said cutting head for effecting movement of said annular tool between a neutral non-orbiting non-cutting position and a position radially offset from an axis of said path so as to orbitally move around said at least one tubular element and a continuous urging of said cutting edge against a radial outer surface of said at least one tubular element to form an ever deepening cut therein;
a frame plate connected to said first and second shafts, wherein a passageway extends through said frame plate and is coaxial with said cutting edge of said annular tool;
a first guide plate and a second guide plate positioned on opposite sides of said cutting head, wherein said first guide plate is supported on said first and second shafts and said second guide plate is commonly supported with respect to said first guide plate; and
a first guide bore extending through said first guide plate and a second guide bore extending through said second guide plate, wherein said first guide bore and said second guide bore are initially coaxial with said cutting edge of said annular tool when in said neutral non-cutting position.

11. The cutting assembly according to claim 10, wherein said second guide plate is connected directly to said first guide plate.

12. The cutting assembly according to claim 10, wherein at least one counterweight is coupled to said cutting head.

13. The cutting assembly according to claim 12, wherein said at least one counterweight includes a first counterweight and a second counterweight;
said first eccentric mechanism is attached to said cutting head at a first attachment location and said second eccentric mechanism is attached to said cutting head at a second attachment location; and
said first counterweight is positioned adjacent said first attachment location and said second counterweight is positioned adjacent said second attachment location.
